(19) United States
(12) Patent Application Publication
(10) Pub. No.: US 2019/0113729 A1
(43) Pub. Date: Apr. 18, 2019

(54) MICROSCOPE APPARATUS

(71) Applicant: OLYMPUS CORPORATION, Tokyo (JP)

(72) Inventor: Masahito DOHI, Tokyo (JP)

(73) Assignee: OLYMPUS CORPORATION, Tokyo (JP)

(21) Appl. No.: 16/140,940

(22) Filed: Sep. 25, 2018

(30) Foreign Application Priority Data
Oct. 13, 2017 (JP) 2017-199500

(51) Int. Cl. G02B 21/00

(52) U.S. Cl. CPC G02B 21/0032; G02B 21/0048

(57) ABSTRACT

A microscope apparatus includes an illumination optical system. The illumination optical system includes an illumination lens that irradiates a sample with light, and two or more reflection members that have a shift function for changing a light-reflection position and/or a rotation function for changing a light-reflection-angle direction. Each of the two or more reflection members is located at a pupil position of the illumination lens, a position pupil-conjugate to the illumination lens, or a position conjugate to a rear focal position of the illumination lens.

### CROSS REFERENCE TO RELATED APPLICATIONS

This application is based upon and claims the benefit of priority from prior Japanese Patent Application No. 2017-199500, filed Oct. 13, 2017, the entire contents of which are incorporated herein by this reference.

### BACKGROUND OF THE INVENTION

### Field of the Invention

The present invention relates to a microscope apparatus that performs sheet illumination.

### Description of the Related Art

A light sheet microscope that forms sheet-like light (sheet light) on a sample surface irradiates only an observed plane with illumination light and thus achieves reduced fading of a biological sample, and is also known as an observation means for enabling fast image capturing. In recent years, it has been considered whether observation techniques that rely on a light sheet microscope can be used in an application of obtaining a stereoscopic image of cultured cells such as spheroid or organoid for screening in drug development in which drug efficiency is evaluated using an image analysis technique, in addition to the conventional application of stereoscopically observing a biological sample such as zebrafish with target molecules labeled by fluorescent protein. Observation techniques based on a light sheet microscope are expected to be applied to a wide range of applications.

A resolution that a light sheet microscope has in the direction of the axis of detection light depends on the thickness of sheet light. For example, using an illumination lens with a high NA may enable an observation with a high resolution.

Japanese Patent No. 5525136 and Japanese Laid-open Patent Publication No. 2016-91006 describe techniques related to a light sheet microscope wherein sheet light is formed to perform scanning.

### SUMMARY OF THE INVENTION

A microscope apparatus in accordance with an aspect of the present invention includes an illumination optical system that forms sheet-like light on a sample, wherein the illumination optical system includes an illumination lens that irradiates the sample with light and two or more reflection members that have a shift function for changing a light-reflection position and/or a rotation function for changing a light-reflection-angle direction, and each of the two or more reflection members is located at a pupil position of the illumination lens, a position pupil-conjugate to the illumination lens, or a position conjugate to a rear focal position of the illumination lens.

### BRIEF DESCRIPTION OF THE DRAWINGS

The present invention will be more apparent from the following detailed description when the accompanying drawings are referenced.

FIG. 1 illustrates the configuration of a microscope apparatus in accordance with a first embodiment;

FIG. 2 illustrates the configuration of a microscope apparatus in accordance with a second embodiment;

FIG. 3 illustrates the configuration of a microscope apparatus in accordance with a third embodiment;

FIG. 4 illustrates the configuration of a microscope apparatus in accordance with a variation of the third embodiment;

FIG. 5 illustrates the configuration of a microscope apparatus in accordance with a fourth embodiment;

FIG. 6 illustrates the configuration of a microscope apparatus in accordance with a fifth embodiment;

FIG. 7 illustrates another exemplary configuration of a microscope apparatus in accordance with the fifth embodiment; and

FIG. 8 illustrates the configuration of a microscope apparatus in accordance with a sixth embodiment.

### DESCRIPTION OF THE EMBODIMENTS

To fully deliver optical performances in observation with a light sheet microscope, optical elements around a sample need to be accurately adjusted, and in particular, the axis of alight flux on an illumination side where the sample is irradiated with light, the axis of alight flux on a detection side, and relative relationships in angle and position between observed planes need to be accurately adjusted. The adjustments have conventionally been performed by directly inclining or shifting a lens on an illumination side relative to an objective on a detection side.

Meanwhile, in a situation in which an illumination lens with a high NA is used for the purpose of enhancing a resolution by decreasing the thickness of sheet light (in such a situation, the NA of an objective on a detection side is also based on the thickness of sheet light), lenses are densely populated near a sample, and an illumination lens and an objective can be moved only within an extremely limited space. Accordingly, in the conventional method, particularly when an illumination lens or objective with such a high NA as to densely populate lenses is used, it has been difficult to accurately adjust optical elements around a sample, and it has also been difficult to perform observation with optical performances stabilized.

In view of the fact described above, an object of the invention is to provide a microscope apparatus that allows the position and angle of the axis of a light flux passing through an illumination lens to be easily adjusted without physically adjusting the illumination lens.

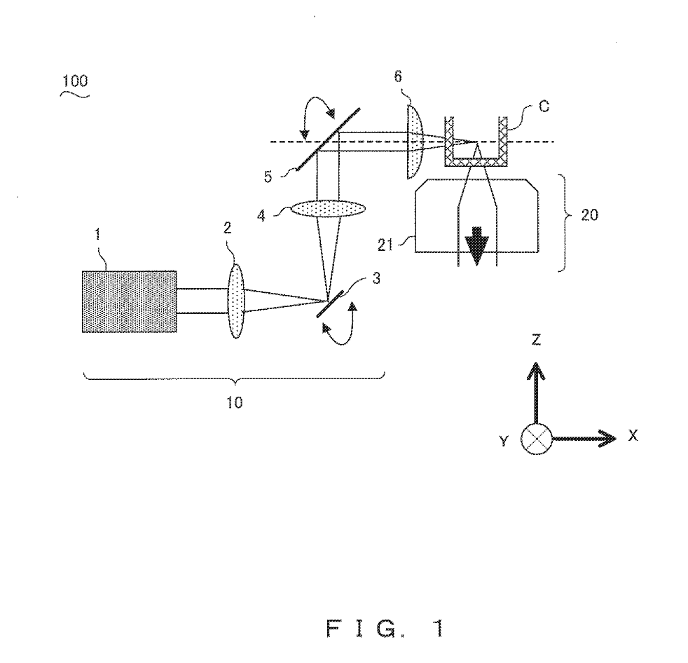

The following describes a microscope apparatus 100 in accordance with a first embodiment of the invention. FIG. 1 illustrates the configuration of the microscope apparatus 100. In the following descriptions, directions are indicated using axial directions defined in FIG. 1 (X, Y, and Z directions). Similarly, other embodiments are also described hereinafter using the directions indicated in the drawings (X, Y, and Z directions).

The microscope apparatus 100 includes an illumination optical system 10 that irradiates a sample with light for illumination (illumination light) so as to form sheet-like light (sheet light) on the sample and a detection optical system 20 that has an optical axis orthogonal to the optical axis of the illumination optical system 10 and that receives light from the sample. The sample is in a light-transmissive container C, and light emitted from the illumination optical system 10 travels to the detection optical system 20 via the sample.

The illumination optical system 10 includes a light source 1, a lens 2, a reflection member 3, a lens 4, a reflection member 5, and a cylindrical lens 6.

The light source 1 outputs illumination light. The lens 2 forms a primary image of the light source 1 by collecting illumination light. The lens 4 relays the primary image of the light source 1 that has been formed by the lens 2 to an optical system on a subsequent stage.

The reflection member 3 is located at the position of the primary image formed by the lens 2, i.e., a position conjugate to a rear focal position of the cylindrical lens 6. The reflection member 3 is a movable mirror and is rotationally moved as depicted in FIG. 1 so as to adjust a light-emission angle (reflection-angle direction). The reflection member 3 is rotationally moved on a Z-X plane (plane defined by the Z and X directions) and on an X-Y plane (plane defined by the X and Y directions).

The reflection member 5 is located at a pupil position of the cylindrical lens 6 or at a position conjugate to the pupil position. The reflection member 5 is a movable mirror similar to the reflection member 3 and is rotationally moved to adjust a light-emission angle. The reflection member 5 is rotationally moved on the ZX and XY planes.

The cylindrical lens 6 serves as an illumination lens for irradiating a sample with illumination light, has power only in the Z direction on the Y-Z plane, and forms sheet light having a width in the Y direction by irradiating the sample with illumination light.

The detection optical system 20 includes an objective 21 and a photodetector (e.g., image sensor) (not illustrated). Light received by the objective 21 is guided to the photodetector, and an image for observation is created on the basis of information obtained by the photodetector.

The following describes operations of the reflection members 3 and 5.

The reflection member 3 located at a position conjugate to a rear focal position of the cylindrical lens 6 is rotationally moved to change a position on an incidence surface of the cylindrical lens 6 on which illumination light is incident. Accordingly, the reflection member 3 functions as a means for changing, through rotational movement, the angle of the axis of a light flux emitted from the cylindrical lens 6 relative to the Z-Y plane orthogonal to the optical axis of the cylindrical lens 6.

The reflection member 5 located at a pupil position of the cylindrical lens 6 or a position conjugate to the pupil position is rotationally moved to change an angle at which illumination light is incident on the incidence surface of the cylindrical lens 6. Accordingly, the reflection member 5 functions as a means for changing, through rotational movement, the position of the axis of a light flux emitted from the cylindrical lens 6 on the Z-Y plane orthogonal to the optical axis of the cylindrical lens 6.

The axis of a light flux indicates the axis of light that actually travels via an optical system. When, for example, light has been incident on a lens at an angle, the axis of a light flux emitted from the lens is moved on a plane orthogonal to the optical axis of the lens, and the axis of the light flux is different in position from the optical axis of the lens. The axis of a light flux emitted from an illumination lens may hereinafter be referred to as an emitted-light axis of the illumination lens.

Accordingly, through movements of the reflection members 3 and 5, the position and angle of the axis of a light flux emitted from the illumination lens (cylindrical lens 6) can be changed on the Z-Y plane. For example, when an emitted-light axis of the illumination lens has been deviated from a prescribed position or angle due to a change in a wavelength output by the light source 1, the functions of the reflection members 3 and 5 may allow the emitted-light axis to be adjusted. The prescribed position or angle refers to a position or angle relative to the optical axis of the illumination lens, or a position or angle that depends on a relative relationship with the objective 21 or a region on a sample in the container C that needs to be observed.

Particularly since the reflection members 3 and 5 are rotationally moved on the Z-X plane and on the X-Y plane, the angle of an emitted-light axis of the illumination lens can be changed relative to every axis orthogonal to the optical axis of the illumination lens (relative to the Z and Y directions), and the position of an emitted-light axis of the illumination lens can be changed in every axial direction. This allows an emitted-light axis of the illumination lens to be freely adjusted on the Z-Y plane.

As described above, the microscope apparatus 100 may adjust an emitted-light axis of the illumination lens (change the position and the angle) by moving the reflection members 3 and 5 provided within the apparatus. Hence, at least for the adjustments that can be completed by the reflection members 3 and 5, no components need to be provided to physically move the illumination lens itself.

Conventionally, an emitted-light axis of an illumination lens has typically been adjusted by moving the illumination lens. However, particularly when an objective or illumination lens with a high NA is used, it has been difficult to accurately adjust optical elements around a sample because lenses are densely populated near the sample. The configuration of the microscope apparatus 100 allows the position and angle of the axis of a light flux emitted from an illumination lens to be easily adjusted without accepting physical limitations from components located near the illumination lens (e.g., objective or container C).

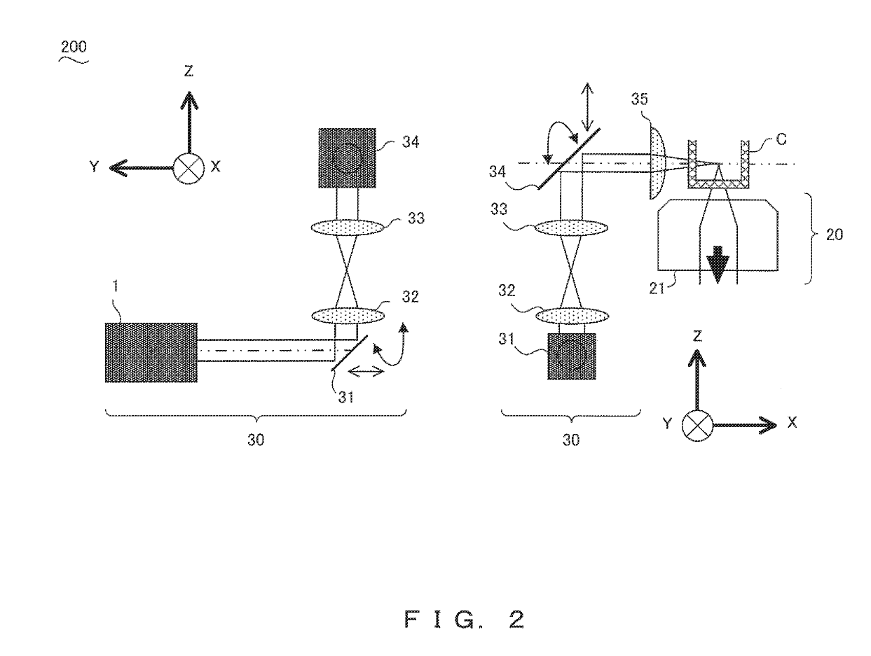

The following describes a microscope apparatus 200 in accordance with a second embodiment. FIG. 2 illustrates the configuration of the microscope apparatus 200. The left-hand side of FIG. 2 depicts the arrangement of the microscope apparatus 200, where an X direction indicates a depth direction of the drawing. The right-hand side of FIG. 2 depicts the arrangement of the microscope apparatus 200, where a Y direction indicates the depth direction of the drawing.

The microscope apparatus 200 includes an illumination optical system 30 that irradiates a sample with illumination light so as to form sheet light on the sample, and a detection optical system 20 that receives light from the sample.

The illumination optical system 30 includes a light source 1, a reflection member 31, lenses 32 and 33, a reflection member 34, and a cylindrical lens 35.

The light source 1, lenses 32 and 33, and cylindrical lens 35 of this configuration have functions similar to those of the light source 1, the lenses 2 and 4, and the cylindrical lens 6, respectively. The cylindrical lens 35 is an illumination lens that irradiates a sample with light.

The reflection member 31 is located at a position pupil-conjugate to the cylindrical lens 35. The reflection member 31 is a movable mirror and changes a light-emission angle and a light-reflection position on the reflection member 31 by being rotationally and linearly moved. In particular, as depicted in FIG. 2, the reflection member 31 is rotationally moved on the X-Y plane and is also moved in a direction in which light is incident (Y direction).

The reflection member 34 is located at a position that is different from the position of the reflection member 31 and that is pupil-conjugate to the cylindrical lens 35 (or may be located at a pupil position of the cylindrical lens 35). The reflection member 34 is a movable mirror and changes a light-emission angle and a light-reflection position on the reflection member 34 by being rotationally and linearly moved. In particular, as depicted in FIG. 2, the reflection member 35 is rotationally moved on the Z-X plane and is also moved in a direction in which light is incident (Z direction).

The following describes operations of the reflection members 31 and 34.

The operation wherein the reflection members 31 and 34 each located at a position pupil-conjugate to the illumination lens are rotationally moved on the X-Y plane and the Z-X plane is similar to that described above with reference to the first embodiment; as with the reflection member 5, the reflection members 31 and 34 change the position of an emitted-light axis of the illumination lens on the Z-Y plane through rotational movement.

The reflection members 31 and 34 each located at a position pupil-conjugate to the illumination lens are moved relative to a direction in which light is incident, thereby changing, in the direction of the movement, a position on the incidence surface of the cylindrical lens 35 on which illumination light is incident. In particular, the reflection members 31 and 34 change the angle of an emitted-light axis of the cylindrical lens 35 relative to the Z-Y plane through the movement relative to a direction in which light is incident.

Accordingly, the advantageous effect achieved by the function of the reflection members 31 and 34 being linearly moved relative to a direction in which light is incident is similar to the advantageous effect of a rotationally movable reflection member located at a position conjugate to a rear focal position of an illumination lens, i.e., the rotationally movable reflection member described above with reference to the first embodiment (reflection member 3). Hence, also in the configuration of the present embodiment, components disposed inside the apparatus facilitate the adjustments of an emitted-light axis of the illumination lens (the changing of the position and angle of the emitted-light axis).

As described above with reference to the first and second embodiments, the reflection members of the present invention that are related to adjustment of an emitted-light axis of an illumination lens (two or more reflection members as will be described hereinafter) are not limited to those having the function for rotational movement to change a light-reflection-angle direction but may have the function for linear movement to change a light-reflection position; alternatively, the reflection members may have both of the functions. Such reflection members are each located at a position conjugate to a rear focal position of the illumination lens, a pupil position of the illumination lens, or a position pupil-conjugate to the illumination lens.

In any case, in the microscope apparatus of the invention, a reflection member located at a pupil position or pupil-conjugate position of an illumination lens (a reflection member rotationally and/or linearly moved) and a reflection member located at a position conjugate to a rear focal position of the illumination lens (a reflection member rotationally and/or linearly moved) may be combined to change the position and angle of an emitted-light axis of the illumination lens on the Y-Z plane.

In particular, in a practical use, the position and angle of an emitted-light axis may be changed for each axial direction on the Y-Z plane (Y direction and Z direction), and in such a situation, two or more reflection members need to be positioned to satisfy the above-described conditions. In other words, one or more of, or all of, the two or more reflection members change the angle of an emitted-light axis of the illumination lens for each axis orthogonal to the optical axis of the illumination lens. One or more of, or all of, the two or more reflection members also change the position of an emitted-light axis of the illumination lens for each axial direction orthogonal to the optical axis of the illumination lens. As examples of such a configuration, the configurations of the microscope apparatuses in accordance with the first and second embodiments have been indicated.

In the microscope apparatus 200 in accordance with the second embodiment, the reflection member 31 is rotationally moved on the X-Y plane, and the reflection member 34 is rotationally moved on the Z-X plane; in a variation, however, the reflection member 34 may be rotationally moved on the X-Y plane and the Z-X plane, and the reflection member 31 may not be rotationally moved. Disposing a reflection member at a position conjugate to a rear focal position of an illumination lens and moving the reflection member relative to a direction in which light is incident changes the angle of illumination light relative to the incidence surface of the illumination lens and thus changes the position of an emitted-light axis of the illumination lens (an advantageous effect similar to that of the reflection member 5 is achieved), and this configuration may be combined. Accordingly, in addition to the combinations described above with reference to the first and second embodiments, there may be other combinations for enabling adjustment of an emitted-light axis of the illumination lens.

Adjusting an emitted-light axis of an illumination lens by moving a reflection member that is a movable mirror would not produce aberration, unlike in, for example, a configuration in which a lens is inclined and moved. Disposing a reflection member at a pupil-conjugate position (pupil position) of an illumination lens or at a position conjugate to a rear focal position of the illumination lens allows the changings of the position and angle of an emitted-light axis of the illumination lens to be controlled independently from each other.

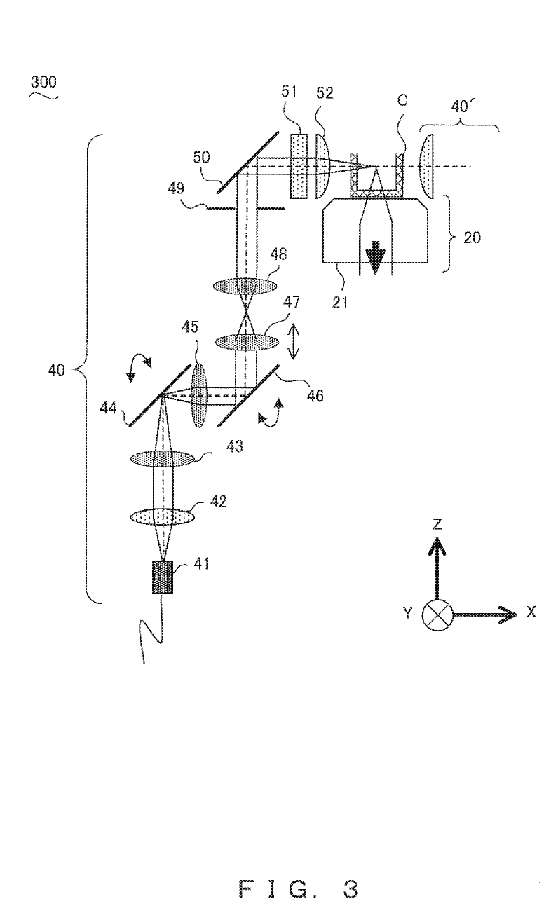

The following describes a microscope apparatus 300 in accordance with a third embodiment. FIG. 3 illustrates the configuration of the microscope apparatus 300.

The microscope apparatus 300 includes an illumination optical system 40 and a detection optical system 20. The microscope apparatus 300 may further include an illumination optical system 40′ that has a configuration similar to that of the illumination optical system 40.

The illumination optical system 40 includes an optical fiber 41 for guiding illumination light from a light source (not illustrated), lenses 42 and 43, a reflection member 44, a lens 45, a reflection member 46, lenses 47 and 48, a diaphragm 49, a galvanometer mirror 50, and cylindrical lenses 51 and 52.

The lens 43 forms a primary image by collecting illumination light from a fiber end surface of the optical fiber 41 that has been guided by the lens 42. The lens 45 relays the primary image formed by the lens 43 to an optical system on a subsequent stage.

The reflection member 44 is located at the position of the primary image formed by the lens 43, i.e., a position conjugate to a rear focal position of the illumination lens (cylindrical lens 52). The reflection member 46 is located at a position conjugate to a pupil position of the cylindrical lens 52. The reflection members 44 and 46 are positioned similarly to the reflection members 3 and 5 described above with reference to the first embodiment and have functions similar to those of the reflection members 3 and 5.

The lens 47 forms an image of an end surface of the optical fiber 41 (a secondary image) by collecting illumination light from the reflection member 46, and the lens 48 relays the formed image to an optical system on a subsequent stage. That is, the lenses 47 and 48 together serve as a relay optical system.

The lens 47 is moved in an optical axis direction by being driven by a motor or the like and thus changes a lens position as depicted in FIG. 3, thereby changing a light-collected position of the illumination lens (cylindrical lens 52) in the X direction. Accordingly, the lens 47 functions as a light-collected-position changing means for changing a light-collected position of the illumination lens in the optical axis direction of the illumination lens.

Further providing the light-collecting-position changing means allows the position of sheet light to be adjusted in the X direction in addition to adjusting the angle and position of an emitted-light axis of the illumination lens on the Y-Z plane.

The diaphragm 49 is capable of changing the size of an aperture on an optical path and changes the size of a light flux at a pupil position of the illumination lens.

The galvanometer mirror 50 serves as a scanning mirror that is rotationally moved on the X-Y plane and that performs scanning, with light emitted to a sample by the illumination optical system 40, in a width direction of sheet light (Y direction) that is an axial direction orthogonal to the optical axis of the illumination optical system 40 and the optical axis of the detection optical system 20.

As with the cylindrical lens 6, the cylindrical lens 52 has power only in the Z direction. The cylindrical lens 51 has power only in the Y direction. Accordingly, sheet light formed by the cylindrical lenses 51 and 52 form diffusion light (or convergent light) in the Y direction, and the entirety of a region on the sample on which sheet light is formed through the scanning performed by the galvanometer mirror 50 can be irradiated. When a light-absorbing material is on a surface irradiated with sheet light, a subsequent stage typically includes a region that is not irradiated with light (fringe). Meanwhile, the cylindrical lenses 51 and 52 and the galvanometer mirror 50 for scanning may be provided to perform scanning with sheet light that includes light with different diffusion angles, thereby illuminating all regions on the surface to be irradiated, and this provides the advantageous effect of eliminating the fringe.

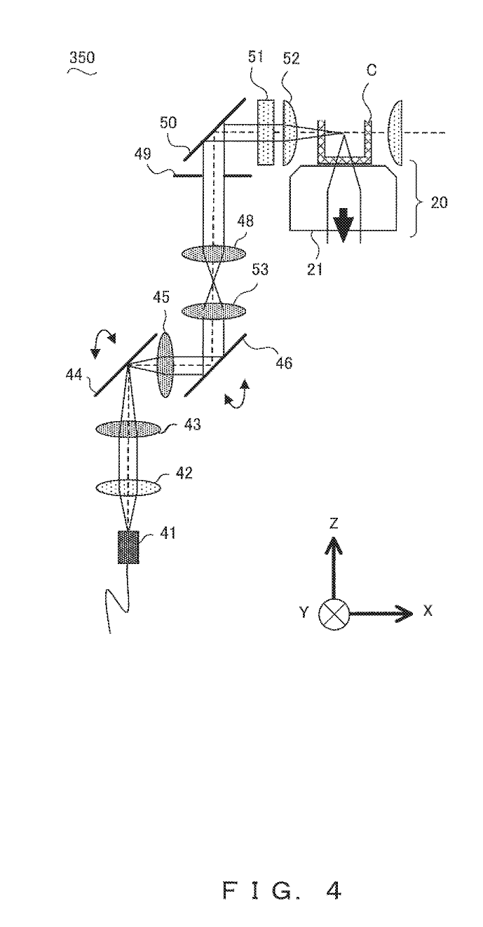

In a variation of the third embodiment, a microscope apparatus 350 may include a varifocal lens 53, rather than the lens 47, as a light-collected-position changing means, as depicted in FIG. 4. Changing the focal length of the varifocal lens 53 may also change the light-collected position of the illumination lens (cylindrical lens 52) in the X direction so that the position of sheet light can be adjusted in the X direction.

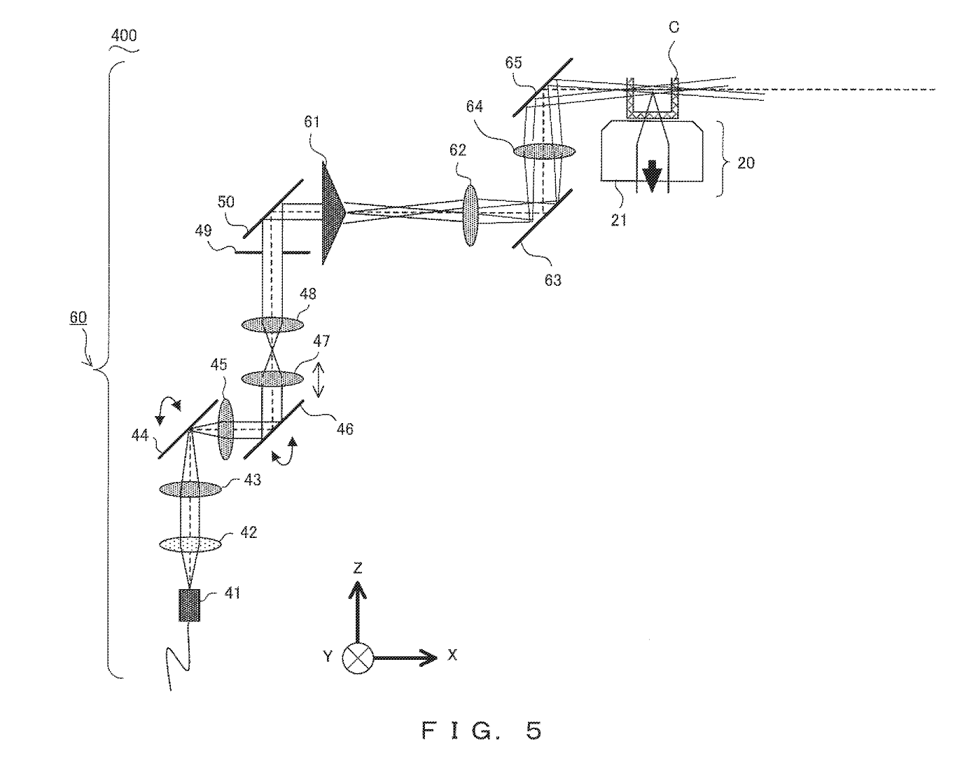

The following describes a microscope apparatus 400 in accordance with a fourth embodiment. FIG. 5 illustrates the configuration of the microscope apparatus 400.

The microscope apparatus 400 includes an illumination optical system 60 and a detection optical system 20. In the illumination optical system 60, like components are given like reference marks to those of the illumination optical system 40 in accordance with the third embodiment. More particularly, the illumination optical system 60 is different from the illumination optical system 40 in that the illumination optical system 60 includes, on the stage subsequent to the mirror 50 (not movable but fixed in this example), an axicon lens 61, a lens 62, a mirror 63, a lens 64, and a galvanometer mirror 65, rather than the cylindrical lenses 51 and 52.

The axicon lens 61 is formed of a conical prism. Light incident on the axicon lens 61 is collected on a plurality of positions on an emitted-light axis of the axicon lens 61 in such a manner as to form line-shaped light, and then a ring-shaped light flux with a certain thickness is formed and incident on the optical system on the subsequent stage.

The lens 62, the mirror 63, and the lens 64 relay the line-shaped light formed on the emitted-light axis of the axicon lens 61 by the axicon lens 61 to a sample surface via the galvanometer mirror 65.

The galvanometer mirror 65 serves as a scanning mirror that is rotationally moved on the X-Y plane and that performs scanning in the width direction (Y direction) with line-shaped light. The galvanometer mirror 65 performing scanning in the width direction (Y direction) with line-shaped light forms sheet light on the sample in a pseudo manner.

The forming of sheet light does not necessarily depend on the cylindrical lens. As in the case of the microscope apparatus 400, sheet light can be formed in a pseudo manner by performing scanning with line-shape light formed by the axicon lens.

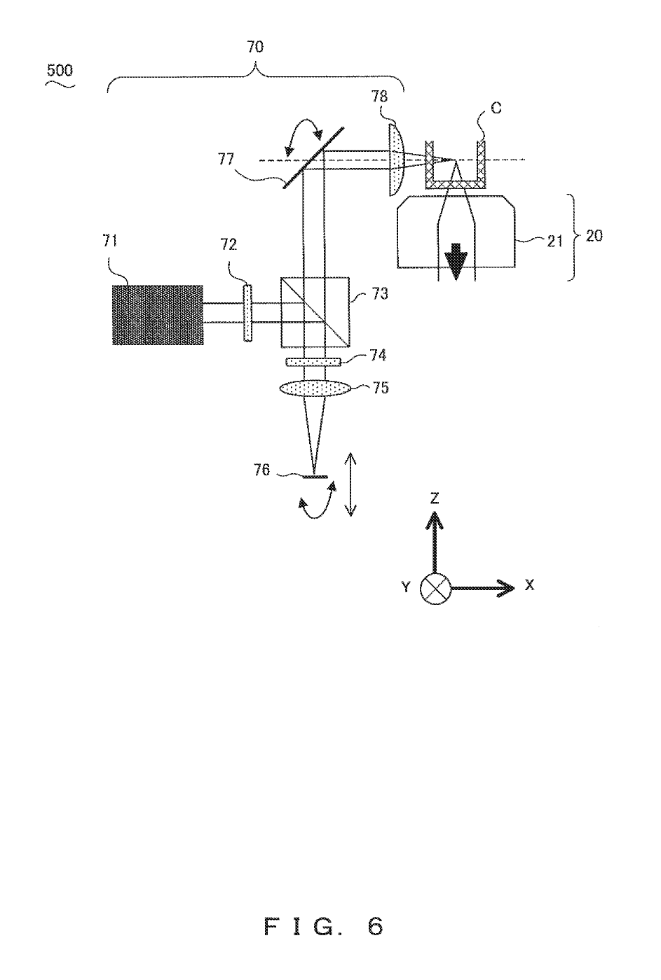

The following describes a microscope apparatus 500 in accordance with a fifth embodiment. FIG. 6 illustrates the configuration of the microscope apparatus 500.

The microscope apparatus 500 includes an illumination optical system 70 and a detection optical system 20.

The illumination optical system 70 includes a light source 71, an illumination filter 72, a polarization beam splitter 73, a ¼λ plate 74, a lens 75, a reflection member 76, a reflection member 77, and a cylindrical lens 78.

The illumination filter 72 is a filter that allows passage only of linearly polarized light among the illumination light output by the light source 71, a ½λ plate that rotates a polarization direction of linearly polarized light, or a polarizing element that is a combination of the filter and the ½λ plate. The illumination filter 72 causes S-polarized light to be incident on the polarization beam splitter 73.

The polarization beam splitter 73 reflects S-polarized light and allows passage of P-polarized light. The ¼λ plate 74 makes a phase difference in incident light and converts linearly polarized light into circularly polarized light. The lens 75 collects light from the ¼λ plate 74 toward the reflection member 76 on the subsequent stage so as to form a primary image of the light source 71.

The reflection member 76 is a folding mirror that reflects light by folding an optical path. The illumination light that is circularly polarized light reflected from the reflection member 76 passes the lens 75 and the ¼λ plate 74 again. In this case, the illumination light passes the same ¼λ plate 74 twice and thus turns into P-polarized light, which then passes the polarization beam splitter 73. The reflection member 76 is moved in the optical axis direction of the lens 75, thereby changing the light-collected position of the cylindrical lens 78, i.e., an illumination lens, in the direction of the axis of the illumination light (X direction). Accordingly, the reflection member 76 functions as a light-collected-position changing means.

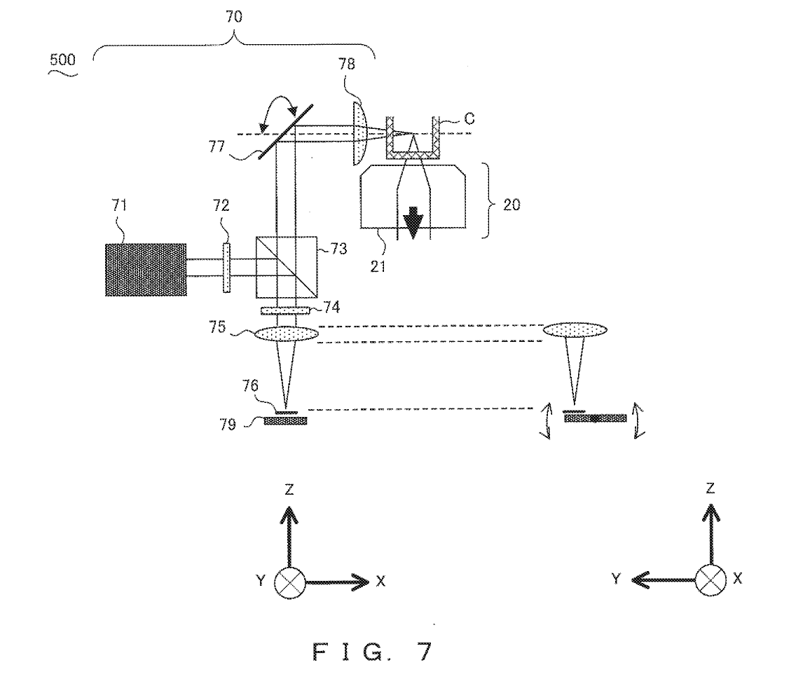

The reflection member 76 is rotationally moved at a position conjugate to a rear focal position of the cylindrical lens 78 (rotationally moved on the Z-X plane and the X-Y plane) , thereby performing operations similar to those of the reflection member 3 and achieving advantageous effects similar to those achieved by the reflection member 3. For example, a galvanometer mirror 79 connected to the stage subsequent to the reflection member 76 as depicted in FIG. 7 may be rotationally moved.

The reflection member 77 is rotationally moved at a pupil position of the cylindrical lens 78 or a position conjugate to the pupil position (rotationally moved on the Z-X plane and the X-Y plane), thereby performing operations similar to those of the reflection member 5 and achieving advantageous effects similar to those achieved by the reflection member 5.

As in the case of the microscope apparatus 500 described above, the light-collected-position changing means is not limited to a lens located on an optical path (e.g., a varifocal lens or a lens moved by being driven by a motor), the light-collected-position changing means may be configured to move, in an optical axis direction, a mirror that folds an optical path. When the reflection member 76 serves as the light-collected-position changing means, adjusting the relationship between the NA of the lens 75 and the NA of the cylindrical lens 78 makes it possible to perform a large scanning of a light-collected-position of the cylindrical lens 78 by slightly moving the reflection member 76.

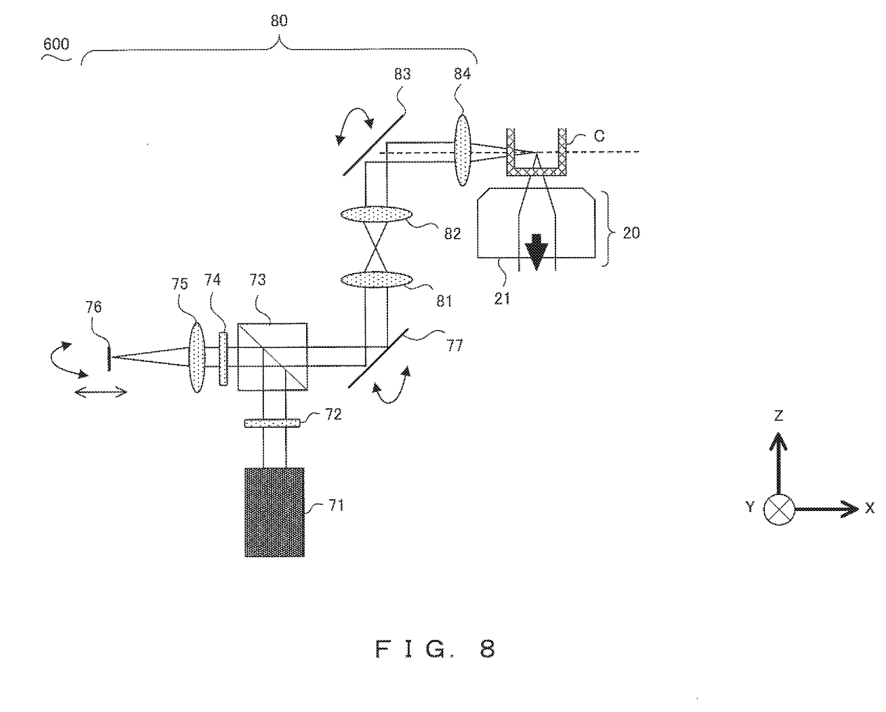

The following describes a microscope apparatus 600 in accordance with a sixth embodiment. FIG. 8 illustrates the configuration of the microscope apparatus 600.

The microscope apparatus 600 includes an illumination optical system 80 and a detection optical system 20. In the illumination optical system 80, like components are given like reference marks to those of the illumination optical system 70 in accordance with the fifth embodiment. More particularly, the illumination optical system 80 is different from the illumination optical system 70 in that the illumination optical system 80 includes lenses 81 and 82, a galvanometer mirror 83, and a lens 84, rather than the cylindrical lens 78.

The galvanometer mirror 83 changes the light-collected position of the lens 84 in the Y direction by performing scanning with illumination light on the X-Y plane.

The lens 84, which is a spherical lens, collects light on one point on a sample surface within the container C and, in accordance with scanning performed by the galvanometer mirror 83, forms sheet light having a width in the Y direction in a pseudo manner.

As in the case of the microscope apparatus 600 described above, the illumination lens is not limited to a cylindrical lens, the illumination lens may form sheet light in a pseudo manner by using a spherical lens and a component for performing scanning with illumination light.

The embodiments described above indicate specific examples to facilitate understanding of the invention, and the present invention is not limited to those embodiments. Various modifications or changes can be made to the microscope apparatuses described above without departing from the scope of the invention defined by the claims.

What is claimed is:

1. A microscope apparatus comprising:
an illumination optical system that forms sheet-like light on a sample, wherein
the illumination optical system includes
an illumination lens that irradiates the sample with light, and
two or more reflection members that have a shift function for changing a light-reflection position and/or a rotation function for changing a light-reflection-angle direction, and
each of the two or more reflection members is located at a pupil position of the illumination lens, a position pupil-conjugate to the illumination lens, or a position conjugate to a rear focal position of the illumination lens.

2. The microscope apparatus of claim 1, wherein
one or more of the two or more reflection members are located at a position conjugate to the rear focal position of the illumination lens.

3. The microscope apparatus of claim 1, wherein
for each of axes orthogonal to an optical axis of the illumination lens, one or more of, or all of, the two or more reflection members change an angle of an axis of a light flux emitted from the illumination lens, and
for each of axial directions orthogonal to the optical axis of the illumination lens, one or more of, or all of, the two or more reflection members change a position of the axis of the light flux emitted from the illumination lens.

4. The microscope apparatus of claim 2, wherein
for each of axes orthogonal to an optical axis of the illumination lens, one or more of, or all of, the two or more reflection members change an angle of an axis of a light flux emitted from the illumination lens, and
for each of axial directions orthogonal to the optical axis of the illumination lens, one or more of, or all of, the two or more reflection members change a position of the axis of the light flux emitted from the illumination lens.

5. The microscope apparatus of claim 1, further comprising:
a detection optical system that has an optical axis orthogonal to an optical axis of the illumination optical system and that receives light from the sample, and
the illumination optical system includes a scanning mirror that scans, in an axial direction orthogonal to both the optical axis of the illumination optical system and the optical axis of the detection optical system, the sample with light emitted to the sample from the illumination optical system.

6. The microscope apparatus of claim. 2, further comprising:
a detection optical system that has an optical axis orthogonal to an optical axis of the illumination optical system and that receives light from the sample, and
the illumination optical system includes a scanning mirror that scans, in an axial direction orthogonal to both the optical axis of the illumination optical system and the optical axis of the detection optical system, the sample with light emitted to the sample from the illumination optical system.

7. The microscope apparatus of claim. 3, further comprising:
a detection optical system that has an optical axis orthogonal to an optical axis of the illumination optical system and that receives light from the sample, and
the illumination optical system includes a scanning mirror that scans, in an axial direction orthogonal to both the optical axis of the illumination optical system and the optical axis of the detection optical system, the sample with light emitted to the sample from the illumination optical system.

8. The microscope apparatus of claim 4, further comprising:
a detection optical system that has an optical axis orthogonal to an optical axis of the illumination optical system and that receives light from the sample, and
the illumination optical system includes a scanning mirror that scans, in an axial direction orthogonal to both the optical axis of the illumination optical system and the optical axis of the detection optical system, the sample with light emitted to the sample from the illumination optical system.

9. The microscope apparatus of claim 1, wherein
the illumination optical system includes a light-collected-position changing mechanism that changes a light-collected position of the illumination lens in an optical axis direction of the illumination lens.

10. The microscope apparatus of claim 2, wherein
the illumination optical system includes a light-collected-position changing mechanism that changes a light-collected position of the illumination lens in an optical axis direction of the illumination lens.

11. The microscope apparatus of claim 3, wherein
the illumination optical system includes a light-collected-position changing mechanism that changes a light-collected position of the illumination lens in an optical axis direction of the illumination lens.

12. The microscope apparatus of claim 4, wherein
the illumination optical system includes a light-collected-position changing mechanism that changes a light-collected position of the illumination lens in an optical axis direction of the illumination lens.

13. The microscope apparatus of claim 5, wherein
the illumination optical system includes a light-collected-position changing mechanism that changes a light-collected position of the illumination lens in an optical axis direction of the illumination lens.

14. The microscope apparatus of claim 6, wherein
the illumination optical system includes a light-collected-position changing mechanism that changes a light-collected position of the illumination lens in an optical axis direction of the illumination lens.

15. The microscope apparatus of claim 7, wherein
the illumination optical system includes a light-collected-position changing mechanism that changes a light-collected position of the illumination lens in an optical axis direction of the illumination lens.

16. The microscope apparatus of claim 8, wherein
the illumination optical system includes a light-collected-position changing mechanism that changes a light-collected position of the illumination lens in an optical axis direction of the illumination lens.

17. The microscope apparatus of claim 9, wherein
the light-collected-position changing mechanism includes a relay optical system that includes a lens that is moved in an optical axis direction.

18. The microscope apparatus of claim 10, wherein
the light-collected-position changing mechanism includes a relay optical system that includes a lens that is moved in an optical axis direction.

19. The microscope apparatus of claim 9, wherein
the light-collected-position changing mechanism includes a varifocal lens.

20. The microscope apparatus of claim 9, comprising:
the light-collected-position changing mechanism includes a folding mirror that reflects light by folding an optical path and a collecting lens that collects light toward the folding mirror, wherein
the folding mirror is moved in an optical axis direction of the collecting lens.
